(19) United States
(12) Patent Application Publication
(10) Pub. No.: US 2024/0383192 A1
(43) Pub. Date: Nov. 21, 2024

(54) BUILD VOLUME PORTIONS

(71) Applicant: HEWLETT-PACKARD DEVELOPMENT COMPANY , L.P., Spring, TX (US)

(72) Inventors: Juan Carlos CATANA SALAZAR, Guadalajara, JAL (MX); Marco Antonio MEDRANO ACOSTA, Guadalajara, JAL (MX); Jun ZENG, Palo Alto, CA (US)

(73) Assignee: HEWLETT-PACKARD DEVELOPMENT COMPANY , L.P., Spring, TX (US)

(21) Appl. No.: 18/708,536

(22) PCT Filed: Nov. 10, 2021
(86) PCT No.: PCT/US2021/058801

§ 371 Date: May 8, 2024

(51) Int. Cl. B29C 64/171; B22F 10/80; B29C 64/386

(52) U.S. Cl. CPC B29C 64/171; B22F 10/80; B29C 64/386

(57) ABSTRACT

Examples of methods are described herein. In some examples, a method includes determining a first portion within a build volume. In some examples, the method includes packing first objects in the first portion. In some examples, the method includes packing using a genetic procedure. In some examples, the method includes packing, using the genetic procedure, second objects in the build volume.

### BACKGROUND

Three-dimensional (3D) solid objects may be produced from a digital model using manufacturing. Additive manufacturing is an example of manufacturing. Additive manufacturing may be used in rapid prototyping, mold generation, mold master generation, and short-run manufacturing. Additive manufacturing involves the application of successive layers of build material. In some additive manufacturing techniques, the build material may be cured or fused. Other machining processes remove material to create the final object.

### BRIEF DESCRIPTION OF THE DRAWINGS

FIG. 1 is a flow diagram illustrating an example of a method for object packing;

FIG. 2 is a block diagram of an example of an apparatus that may be used in object packing;

FIG. 3 is a block diagram illustrating an example of a computer-readable medium for performing object packing;

FIG. 4 is a diagram illustrating a perspective view of an example of a build volume including a first portion and a second portion in accordance with some examples of the techniques described herein; and

FIG. 5 is a diagram illustrating a perspective view of an example of a packed build volume in accordance with some examples of the techniques described herein.

### DETAILED DESCRIPTION

Manufacturing techniques (e.g., additive manufacturing, three-dimensional (3D) printing, etc.) may be used to manufacture 3D objects. Some examples of manufacturing may utilize a packing. A packing is information that specifies a positioning of objects in a volume. A positioning is a position(s), location(s), and/or orientation(s), etc., of an object or objects. An “object” may refer to a geometrical representation and/or 3D shape. A volume is a 3D space.

A build volume is a volume that may be used for manufacturing. In some examples, a build volume may correspond to a physical space in which additive manufacturing may be performed. In some examples, a volume, build volume, or volume subset may be structured as a 3D space bounded by a polyhedron (e.g., a set of vertices, edges, and faces) that specifies the packing space scope. For example, a cuboidal space may be defined by 8 vertices (e.g., V={v1=(0,0,0), v2=(0,20,0), v3=(20,0,0), v4=(20,20,0), v5=(0,0,80), v6=(0,20,80), v7=(20,0,80), v8=(20,20,80)}), 12 edges (e.g., E={e1=(v1,v2), e2=(v1,v3), e3=(v1,v5), e4=(v2,v4), e5=(v2,v6), e6=(v3,v4), e7=(v3,v7), e8=(v4,v8), e9=(v5,v6), e10=(v5,v7), e11=(v6,v8), e12=(v7,v8)}), and 6 faces (e.g., F={f1={e1,e7,e10,e3}, f2={e6,e8,e12,e7}, f3={e8,e11,e5,e4}, f4={e2,e5,e9,e3}, f5={e1,e6,e4,e2}, f6={e10,e12,e11,e9}}). Different vertices, edges, and/or faces (and/or quantities thereof) may be utilized in some examples. In some examples, a build volume (e.g., packing space) may be a cuboidal space with x, y, and z dimensions. For example, a build volume may be a cuboid with dimensions of 284 millimeters (mm) in the x axis by 380 mm in the y axis by 380 mm in the z axis. It may be helpful to increase packing density in a build volume to increase production and/or reduce manufacturing costs.

In some examples, object packing may be based on an objective or objectives. An example of an objective is packing density (e.g., increasing or maximizing packing density). Object packing questions may be computationally intensive to solve, being nondeterministic polynomial- (NP-) complete. For example, computational complexity may grow exponentially in NP-complete questions. For instance, the size of the solution space (e.g., quantity of possible packings) for placement of objects (without rotation, for example) in a relatively small batch of 20 objects, is beyond the order of 1×10¹⁸.

Throughout the drawings, identical or similar reference numbers may or may not designate similar and/or identical elements. When an element is referred to without a reference number, this may refer to the element generally, without limitation to any particular drawing or figure. The drawings may or may not be to scale, and the size of some parts may be exaggerated to more clearly illustrate the example shown. Moreover, the drawings provide examples in accordance with the description. However, the description is not limited to the examples provided in the drawings.

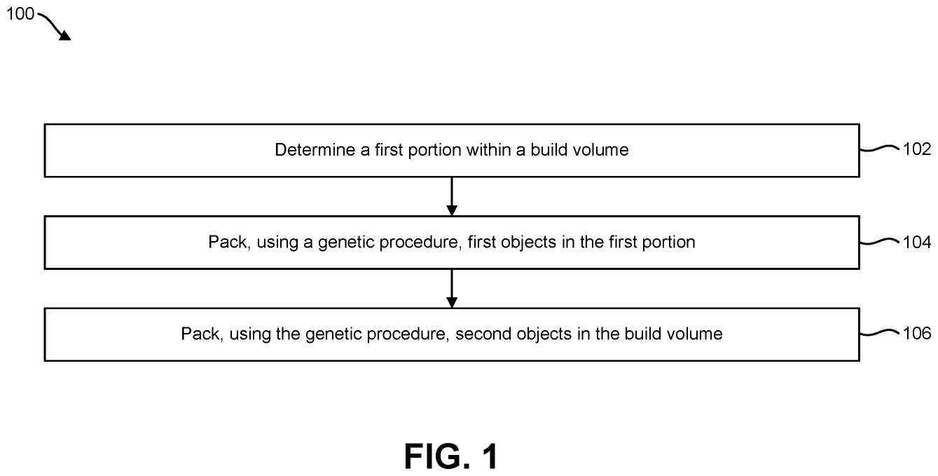

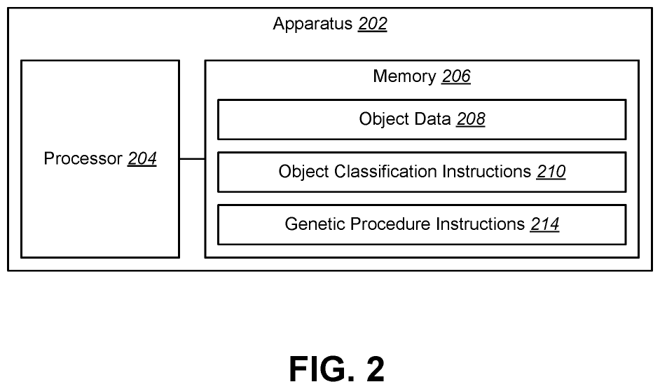

FIG. 1 is a flow diagram illustrating an example of a method 100 for object packing. The method 100 and/or a method 100 element or elements may be performed by an apparatus (e.g., electronic device). For example, the method 100 may be performed by the apparatus 202 described in relation to FIG. 2.

An apparatus may determine 102 a first portion within a build volume. A portion within a build volume is a subset of the build volume. For instance, a portion may be a volume within the build volume. In some examples, a portion may be defined by a polyhedron, cuboid, sphere, or other shape (e.g., regular or irregular shape, symmetrical or asymmetrical shape). In some examples, the apparatus may determine 102 the first portion based on received information. For instance, the apparatus may receive information from a computing device, input device (e.g., mouse, keyboard, touchscreen, microphone, camera, scanner, etc.), and/or another apparatus indicating the size and/or position of the first portion. For example, the apparatus may receive information indicating vertices of a polyhedron and/or a position of the polyhedron in build volume coordinates. The apparatus may determine 102 (e.g., set, establish, calculate, etc.) the first portion based on the received information.

In some examples, the apparatus may determine 102 the first portion based on an object or objects. For instance, the apparatus may determine a size, shape, and/or position of a portion (e.g., first portion, second portion, etc.) based on an attribute(s) of an object(s) (e.g., first objects). In some examples, the apparatus may determine a size of a portion based on a volume(s) of the object(s). For instance, the apparatus may determine a size of a portion as a proportion (e.g., 50%, 60%, 75%, 83%, 90%, etc.) of a cumulative bounding box volume of a set of objects (e.g., 20% less volume than a volume sum of first objects). In some examples, the apparatus may determine a portion with a default shape (e.g., cube, rectangular prism with a default width-to-height ratio, cuboid with base dimensions matching the build volume, etc.) having the determined volume. In some examples, a dimension or dimensions of a portion may be determined as a largest corresponding dimension or dimensions of bounding boxes of a set of objects (e.g., first objects).

In some examples, a position of the first portion may be a default position and/or may be determined based on another (e.g., previously determined) portion or previously packed object. For instance, the first portion (e.g., a vertex of the first portion) may be positioned at a corner of the build volume, at a corner of another portion, at an offset (e.g., 1 millimeter (mm) offset, 2 mm offset, interior offset, exterior offset, etc.) from another portion, at a distance from a previously packed object, etc. In some examples, the apparatus may determine a position of the first portion that separates the first portion from another portion. In some examples, a position of the first portion may be within another portion. For instance, portions within the build volume may be disjoint or overlapping in some approaches.

The apparatus may pack 104, using a genetic procedure, first objects in the first portion. The first objects are a group of objects. A group is a collection of objects and/or representations (e.g., genes, object data, a chromosome, etc.) of objects. For instance, the first objects may be a subset of a set of objects to be packed. In some examples, the method 100 may include classifying a set of objects to determine the first objects. For instance, the apparatus may select a subset of the set of objects as the first objects. In some examples, the apparatus may classify another group or groups of objects (e.g., second objects, third objects, etc.). For instance, the apparatus may classify second objects (e.g., other objects, non-first objects, etc.). In some examples, classifying the first objects may establish non-first objects as the second objects. In some examples, classifying the set of objects may be based on a criterion or criteria.

A criterion is (or criteria are) a condition(s) (e.g., threshold(s), rule(s), etc.) associated with a characteristic(s), value(s), quantity(ies), and/or indicator(s) that can be utilized to classify (e.g., categorize, group, etc.) objects. An object or objects may have an associated criterion or criteria and/or the apparatus may determine a characteristic(s), value(s), quantity(ies), and/or indicator(s) for the object or objects related to the criterion or criteria. Examples of a criterion may include a condition relating to a geometrical feature (e.g., shape type, shape descriptor (indicating whether an object is concave or convex, and/or geometrical complexity, etc.), priority (e.g., received user input indicating a priority), volume, size, width, height, bounding box size, thickness, whether the object is nestable, etc.

In some examples, classifying the objects may include grouping objects based on the criterion or criteria. For instance, objects having characteristic(s), value(s), quantity(ies), and/or indicator(s) that satisfy a criterion or criteria (e.g., threshold(s), rule(s), etc.) may be classified as first objects, while other objects (e.g., objects that do not satisfy the criterion or criteria) may be classified as second objects. Some of the examples provided herein describe first objects and second objects. In some examples, other quantities of groups may be utilized. For instance, objects may be classified into two, three, four, five, eight, ten, etc., groups. In some examples, different groups may be classified utilizing different criteria. For instance, the first objects may be classified using a first criterion, second objects may be classified using a different second criterion, and third objects may be remaining objects (e.g., non-first objects and non-second objects).

In some examples, a geometrical feature or features (e.g., geometrical complexity) may be utilized to classify the objects. For instance, some objects may be classified as first objects based on a geometrical feature(s). In some examples, manufacturing quality may vary based on location within a build volume. For instance, the first portion may be a portion of the build volume that is more likely to produce higher quality objects. In some examples, objects with more complex geometry (e.g., smaller features, sharper features, etc.) and/or greater target geometrical precision may be classified as first objects. Other objects (e.g., second objects) may have less complex geometry and/or lesser target geometrical precision. In some examples, the apparatus may classify objects having a complexity (e.g., complexity measure, feature size, surface variation measure, roughness measure, quantity of holes, quantity of protrusions, and/or angular variation measure, etc.) that satisfies a complexity criterion (e.g., complexity threshold, feature size threshold, surface variation threshold, etc.) as first objects. For instance, if an object includes a feature that is smaller than a feature size threshold and/or includes a surface that exceeds a roughness threshold, the apparatus may classify the object as a first object. In some examples, the first portion may be located lower in a build volume (e.g., at a lower z-height of the build volume), which may be more likely to provide greater manufacturing quality.

In some examples, an object quantity (e.g., quantity of objects) may be utilized to classify the objects, where a quantity of objects may be classified as first objects. For instance, a threshold quantity of objects may be classified as first objects for packing in the first portion.

In some examples, a priority (e.g., priority input, designated priority, etc.) may be utilized to classify the objects. In some examples, objects that meet a priority criterion (e.g., highest priority) may be classified as first objects. For instance, the apparatus may receive a priority input from an input device indicating a priority for an object or objects. For example, the apparatus or another device may receive an input (e.g., keyboard input, touchscreen input, mouse input, wireless signal, and/or stylus input, etc.) that indicates the priority. For example, an entity (e.g., user, business, etc.) may indicate a priority and/or an apparatus may receive a priority input as a classification criterion. The apparatus may classify objects based on the priority associated with each object. For instance, priority inputs may indicate group numbers (e.g., “1,” “2,” “3,” etc.), which may be utilized to classify the objects into corresponding groups. Groups may be ordered in priority order (e.g., from highest to lowest priority) in some examples. In some examples, an object or objects with a higher priority may be packed before an object or objects with a lower priority (e.g., higher priority objects may be packed before lower priority objects). For example, a first group may have a first priority and a second group may have a second priority, where the first priority is higher than the second priority.

It some cases, it may be helpful to prioritize object packing for manufacturing. For instance, when selecting objects (from a pool of objects, for example) for packing into a build volume for batch production, an object or group of objects may be given priority for entrance into the build volume, for packing in the build volume, and/or for manufacturing. In some examples, an object or objects with lower priority may bear a risk of being left out of the current build volume and/or waiting for a subsequent build volume. A priority is a rank, level in a hierarchy, and/or position in an order.

In some examples, objects with a same or similar priority may be packed near each other in the volume. For instance, objects with a same or similar priority may be packed at a same or similar z-height in the volume. Packing objects with a similar priority at a similar z-height may be helpful for some types of additive manufacturing technologies (e.g., multi-jet fusion (MJF)), where manufactured object quality may depend on the object's packing location in the z dimension. In some examples, objects that are assigned the same priority may have similar quality and/or may be manufactured in similar time frames. In some examples, a higher priority group may be processed and/or packed first, and a lower priority group may be processed and/or packed later.

In some examples, the apparatus may pack the first objects in the first portion using a genetic procedure. A genetic procedure is a computational procedure. For example, a genetic procedure may be a metaheuristic procedure that includes evolution and/or selection mechanisms for determining a solution. In some examples, a genetic procedure may be a technique utilized in artificial intelligence. In some examples, the genetic procedure may include initializing a population, evaluation, selection, crossover, and/or mutation operations. In some examples, evaluation, selection, crossover, and/or mutation may be performed repeatedly (e.g., iteratively, recursively, etc.) until an end condition is met. In some examples, packing 104 first objects using a genetic procedure may be performed in initializing a population, crossover, and/or mutation operations. A population is a group or set of chromosomes. In some examples, the apparatus may perform a genetic procedure using a chromosome or chromosomes.

A chromosome is data. For example, a chromosome may include data representing a potential solution for a question that the genetic procedure is to address. A chromosome may include and/or represent a set of objects (e.g., first objects, second objects, etc.). In some examples, a chromosome may include data indicating a set of object identifiers and poses. An object identifier is information (e.g., number, floating point number, integer, string, character(s), name, etc.) that identifies an object. A pose is information indicating a location and/or orientation of an object. For instance, a pose may indicate a location (e.g., translation) of an object in a build volume (e.g., first portion) and/or an orientation (e.g., rotation(s) in a dimension or dimensions) of an object in a build volume (e.g., first portion). In some examples, a pose may be expressed as a number or numbers (e.g., floating point numbers, integers, etc.), vector(s), matrix or matrices, quaternion(s), etc. In some examples, a chromosome may include an object identifier with a first axis rotation (e.g., x), a second axis rotation (e.g., y), and a third axis rotation (e.g., z) for each of a set of objects (e.g., first objects, second objects, etc.). In some examples, a gene of a chromosome may represent an object. In some examples, a chromosome may include an object identifier with an orientation (and without location, for instance) for each of a set of objects. In some examples, each gene of a chromosome may include an object identifier and/or pose (e.g., orientation and/or location).

In some examples, a chromosome may include data for each object in an order or sequence. In some examples, the order or sequence of a chromosome may correspond to a packing order in a volume (e.g., first portion, second portion, build volume, etc.). For instance, the apparatus may place the objects of a chromosome in the volume (e.g., first portion) in the order or sequence indicated in the chromosome. In some cases, consecutive objects in a chromosome may be placed adjacently in the volume if volume dimensions allow, to an extent that volume dimensions allow, and/or to an extent that previously-placed object(s) allow. In some examples, the order or sequence may establish a queue. For instance, the order or sequence may indicate an order that objects may be introduced into a build volume. In some examples, a chromosome may include an object identifier and rotations for respective objects from object 1 to object n. For instance, a chromosome may encode an object list (e.g., list of genes), where each element of the list indicates an identifier of an object and/or rotation angles corresponding to axes (e.g., in x, y, and/or z axes). In some examples, the order or sequence of a chromosome may be an order or sequence of object identifiers. In some examples, each chromosome may represent a potential packing described as a sequence of object identifiers with associated poses. For instance, a chromosome may indicate a packing order of objects in a volume (e.g., first portion, second portion, build volume, etc.). A packing is an organization of objects. For instance, a chromosome may indicate an object attention queue or sequence, and a placement procedure may locate the objects in a volume (e.g., first portion) in the chromosome order.

In initializing a population, the apparatus may randomly initialize a set of chromosomes and/or portions of chromosomes. For example, the apparatus may utilize a random number generator to generate random poses for a set of objects (to be packed in a first portion, second portion, or build volume, for instance). In some examples, the initialized set of chromosomes and/or portions of chromosomes may include sequences of object identifiers and poses. In some examples, the apparatus may initialize a chromosome for a group of objects. For instance, the apparatus may initialize a set of chromosomes for the first objects. For example, the apparatus may randomly initialize object ordering and/or poses for the first objects.

In some examples, packing for an object group (e.g., first objects, second objects, etc.) may be processed using chromosomes in a genetic procedure instance. A genetic procedure instance is the performance of a genetic procedure to an end condition (e.g., multiple iterations are performed until an end condition is reached) for an object group. For example, a genetic procedure instance for the first objects may be performed until an end condition is reached for the first objects. A genetic procedure instance for second objects may then be performed until an end condition is reached for the second objects. In some examples, an object group (e.g., first objects, second objects, etc.) may preserve object membership throughout a genetic procedure instance. For example, when a chromosome is created and/or when a mutation is performed, the object identifiers in the chromosomes representing an object group (e.g., first objects, second objects, etc.) may be maintained and/or preserved. Mutations may modify object orientations and/or an object sequence inside a chromosome or chromosomes. In some approaches, the genetic procedure may proceed (e.g., evaluation may be) based on chromosome fitness.

In performing evaluation, the apparatus may evaluate and/or rank the chromosomes according to a value or values. Examples of values include fitness scores. A fitness score is a measure, metric, or score that indicates a degree to which a chromosome (e.g., packing) satisfies an objective or objectives (e.g., increased packing density, decreased packing height, and/or decreased z-axis measure, etc.). For example, the fitness score may be evaluated for each chromosome (e.g., packing). Examples of fitness scores may include quantity of objects packed, packing density, and/or packing height (e.g., z-height). The quantity of objects packed is a quantity of objects that fit within a volume (e.g., first portion, second portion, build volume, etc.) for a chromosome. A quantity of objects packed may be determined for each chromosome.

In some examples, a value or values (e.g., fitness score, quantity of objects packed, packing density, and/or packing height, etc.) may be utilized to rank or order chromosomes. In some examples, a group of values (e.g., fitness score, quantity of objects packed, packing density, and/or packing height, etc.) may be assembled and/or combined to form a packing score that can be utilized to rank one packing over another packing. For instance, a packing score may be determined based on a function, combination, mapping, weighted sum, average, etc., of multiple values (e.g., fitness score, quantity of objects packed, packing density, and/or packing height, etc.). In some examples, chromosomes with a relatively greater packing density, a relatively greater quantity of objects packed, and/or a relatively lesser packing height may be ranked higher than other chromosomes.

In some examples, the value(s) (e.g., fitness score(s), packed quantity(ies), packing density(ies), and/or packing height(s), etc.) may be determined based on a placement procedure. An example of a placement procedure is a bottom-front-left placement procedure. For instance, the objects of a chromosome may be placed in a volume (e.g., first portion, second portion, build volume, etc.) in accordance with the placement procedure to produce a packing. The value(s) (e.g., fitness score(s), packed quantity(ies), packing density(ies), and/or packing height(s), etc.) may be determined (e.g., calculated, computed, etc.) based on the packing.

In some examples, a bottom-front-left placement procedure may utilize the object sequence of a chromosome to enter each object in sequence (e.g., one after another in the given order). The bottom-front-left placement procedure (e.g., heuristic) may enter an object from a top-back-right corner of a volume (e.g., first portion, second portion, build volume subset, and/or build volume, etc.), and move (e.g., incrementally move, continuously move, etc.) the object downward (e.g., along a z axis) until contacting with (or colliding with or coming within a distance from) another object or contacting with (or colliding with or coming within a distance from) a volume (e.g., first portion, second portion, build volume subset, and/or build volume, etc.) frontier (e.g., edge, boundary, face, etc.). Examples of the distance may include 0.01 mm, 0.1 mm, 0.5 mm, 1 mm, 2 mm, 5 mm, etc. The object may then be moved from a back of the volume (e.g., first portion, second portion, build volume subset, and/or build volume, etc.) frontward (e.g., along a y axis) until contacting with (or colliding with or coming within a distance from) another object or contacting with (or colliding with or coming within a distance from) a volume (e.g., first portion, second portion, build volume subset, and/or build volume, etc.) frontier. The object may then be moved from a right side of the build volume (or volume subset) leftward (e.g., along an x axis) until contacting with (or colliding with or coming within a distance from) another object or contacting with (or colliding with or coming within a distance from) a volume (e.g., first portion, second portion, build volume subset, and/or build volume, etc.) frontier. Other placement procedures may be utilized in some examples. For instance, other placement procedures that place the objects of the chromosome(s) proceeding in different directions may be utilized in some examples.

In performing selection, the apparatus may eliminate a quantity of the chromosomes. For instance, the apparatus may eliminate (e.g., discard, delete, remove, exclude, etc.) a quantity of the lowest ranked chromosomes (e.g., a percentage of lowest ranked chromosomes, a quantity of lowest ranked chromosomes, etc.). In some examples, the chromosomes may be categorized based on rank. For example, a first quantity (e.g., percentage of chromosomes, quantity of chromosomes, etc.) of the chromosomes may be categorized in a first category. For instance, the first quantity may be a set of highest ranked chromosomes. The first quantity of chromosomes may be referred to as elite chromosomes (e.g., a quantity of chromosomes with best fitness scores, quantities of objects packed, packing height, and/or packing density). In some examples, a gene or genes (e.g., object identifier(s) and/or pose(s)) of the elite chromosomes may be preserved and/or propagated to a subsequent (e.g., next) generation of chromosomes. A generation is a set of chromosomes (e.g., packings). For example, a generation may correspond to each iteration of the genetic procedure.

In some examples, selection may include chromosome selection for propagation (e.g., mutation and/or crossover) and/or packing (e.g., selecting a chromosome for a packing solution). For instance, the apparatus may select a chromosome or chromosomes based on a rank that is based on fitness scores, quantities of objects packed, packing density, and/or packing height, etc.

In some examples, selecting a chromosome may be based on a value or values. In some examples, selecting a chromosome for propagation is based on a fitness score. For example, a chromosome or chromosomes with better (e.g., a set of top) fitness scores may be selected for propagation and/or packing. For instance, selecting a chromosome for propagation may be based on a quantity of objects packed. For instance, chromosomes with higher quantities of objects packed, higher packing density, and/or lower packing height may be selected for propagation and/or packing. In some examples, first portions of chromosomes corresponding to the first object(s) may be propagated without modification to a subsequent generation or generations. In some examples, the chromosomes may not include portions corresponding to the first object(s).

In performing crossover, the apparatus may utilize a second quantity of chromosomes and elite chromosomes. The second quantity of the chromosomes may be referred to as crossover chromosomes. The second quantity of chromosomes may be ranked below the elite chromosomes. For instance, the apparatus may randomly select chromosomes that are ranked below the elite chromosomes to select the crossover chromosomes. The apparatus may crossover the crossover chromosomes with the elite chromosomes. For example, the apparatus may combine a part or parts (e.g., gene(s), object identifier(s), pose(s), location(s), orientation(s), rotation(s), and/or sequence position(s)) of an elite chromosome with a part or parts (e.g., gene(s), object identifier(s), pose(s), location(s), orientation(s), rotation(s), and/or sequence position(s)) of a crossover chromosome to generate a child chromosome in a subsequent (e.g., next) generation of chromosomes.

In performing mutation, the apparatus may randomly mutate an elite chromosome or elite chromosomes. For example, the apparatus may randomly change a gene or genes (e.g., object identifier(s), pose(s), location(s), orientation(s), rotation(s), and/or sequence position(s)) of an elite chromosome or elite chromosomes. The chromosomes to be mutated may be referred to as mutation chromosomes.

In some examples, a constant population size (e.g., quantity of chromosomes) may be maintained over generations. In some examples, the population size may vary over generations. In some examples, new random chromosomes may be added. For instance, a set of randomly generated chromosomes may be added to the elite chromosomes, crossover chromosomes, and mutation chromosomes. For instance, adding new random chromosomes may maintain the constant population size. The random chromosomes may be useful for driving a random search in different directions in the solution space. In some approaches, mutations of chromosomes may be represented as random movements in the object sequence and/or random rotations on the object orientations. The mutation stage may be utilized to mutate elite chromosomes (e.g., good solutions) into chromosomes with increased fitness (e.g., better solutions). Performing selection, crossover, and/or mutation may produce a subsequent generation of chromosomes.

In some examples, an operation or operations of the genetic procedure may repeat (e.g., iterate, recur, etc.). For example, evaluation, crossover, and/or mutation may be repeated for subsequent generations of chromosomes until an end condition is met (e.g., a threshold quantity of generations, a threshold quantity of packed objects, a threshold fitness score, and/or a threshold packing score, etc.).

In some examples, the apparatus may pack 104 the first objects in the first portion using the genetic procedure to produce a packing within the first portion (e.g., first portion packing). For example, an instance of the genetic procedure may be executed within the bounds of the first portion. The genetic procedure instance may produce a packing within the bounds of the first portion.

In some examples, packing 104 the first objects in the first portion may be based on a constraint associated with the first portion. A constraint is a rule. For instance, a constraint associated with a portion may be a rule that governs (e.g., restricts) packing and/or the genetic procedure for that portion. In some examples, the constraint associated with the first portion may include voxel size, spacing (e.g., inter-object spacing), and/or orientation. For instance, a voxel size constraint may set the voxel size for a portion. The voxel size may impact how finely or coarsely the object(s) are represented in the portion. In some examples, the voxel size may impact object positioning for approaches that locate objects accordance with the voxel grid. A spacing (e.g., inter-object spacing) constraint may set a margin between objects (e.g., a minimum distance allowed between objects) in a portion. For instance, the spacing constraint may restrict object location such that objects are spaced by a minimum spacing distance or greater. An orientation constraint may set an axis or axes of rotation (e.g., yaw, pitch, and/or roll) for objects in a portion. For instance, an orientation constraint may restrict potential rotation of objects in the portion to a rotation range (e.g., within ±45°, within ±15°, etc.) or a rotation angle (e.g., +22° roll, +11 pitch°, etc.) for an axis or axes of rotation.

The apparatus may pack 106, using the genetic procedure, second objects in the build volume. For example, the apparatus may execute a second instance of the genetic procedure to pack second objects (e.g., non-first objects, a second group of objects, etc.) in the build volume. In some examples, the second objects may be packed in any unoccupied space in the build volume. For instance, the second objects may be packed within the first portion (e.g., unoccupied space in the first portion), partially in the first portion (e.g., across a first portion boundary), and/or outside of the first portion.

In some examples, the second objects may be packed in a second portion within the build volume. For instance, a second portion may be determined as similarly described herein relative to the first portion. In some examples, the second portion may be disjoint from the first portion, may border the first portion, or may overlap with the first portion. For instance, the second portion may overlap with the first portion. In some examples, the apparatus may determine whether the first portion and the second portion overlap. For instance, the apparatus may determine coordinate ranges of an overlapping region and/or may determine an overlapping polyhedron between the first portion and the second portion.

Overlapping the second portion with the first portion may permit some or all of the second objects to be packed within the first portion, partially in the first portion, or outside of the first portion in the second portion. In some examples, the apparatus may perform collision detection in an overlapping region between the first portion and the second portion. For instance, the apparatus may perform collision detection in the overlapping region during a placement procedure for the second objects. In some examples, collision detection for the second objects may be restricted to the overlapping region and/or the second region. For instance, previously packed first objects or portions of first objects (e.g., truncated object geometry) in the overlapping region may be loaded for collision detection. In some examples, first objects or portions of first objects outside of the overlapping region may not be loaded to reduce processing during collision detection while packing the second objects. In some examples where the first portion and the second portion are disjoint (e.g., non-overlapping), the first objects may not be loaded during second object packing and/or collision detection. In some examples, whole previously packed first objects and/or all previously packed first objects may be loaded for collision detection. In some examples, collision detection in the overlapping region may include a multi-stage (e.g., two-stage) collision detection (e.g., detecting any collision between a second object and any previously placed second object(s), detecting any collision between the second object and second portion boundary(ies), and/or detecting any collision between the second object and/or any previously packed first object(s) in the overlapping region).

In some examples, packing 106 the second objects in a second portion is based on a second constraint that is different from a first constraint associated with the first portion. For instance, the first constraint may restrict orientation on a roll axis to +22° and the second constraint may restrict orientation on a roll axis to −22°. In some examples, other different constraints may be utilized (e.g., different voxel sizes, different spacings, and/or different orientations). In some examples, a first constraint may not be applied outside of packing the first portion (e.g., may not be applied in packing the second portion and/or in packing the build volume after the first portion is packed). In some examples, the first constraint may be applied after packing the first portion for any other object that is located within the first portion and/or partially within the first portion. For instance, if a second object is packed within a first portion, a spacing constraint within the first portion may be maintained for the second object in some approaches.

In some examples, the apparatus may classify the second objects as described above. In some examples, the second objects may be classified based on the first portion packing. In some cases, for instance, not all first objects may fit into the first portion for the first portion packing. An object that does not fit into an associated portion may be referred to as a spillover object. For instance, the apparatus may determine a spillover object(s) from the first objects. For example, if the genetic procedure and/or placement procedure does not fit an object within an associated portion (e.g., within a boundary or boundaries of the portion), the apparatus may determine that the object is a spillover object. In some examples, the apparatus may classify a spillover object into another group that is different from the initial group of the object. For instance, the apparatus may determine a spillover object from the first objects and classify (e.g., re-classify) the spillover object as a second object.

In some examples, the first objects and the second objects may be copies of a prototype object. For instance, the apparatus may attempt to pack as many copies of a prototype object as possible into a portion or portions of the build volume in some approaches. In some examples, the apparatus may create copies of a prototype object, where the copies have the same geometrical structure as a prototype object and different identifiers. For instance, copies of a prototype object may be expressed in different genes. The apparatus may execute the genetic procedure to pack as many copies of the prototype object into the first portion, where a chromosome with a largest number of objects and/or a highest packing density may be selected as the first portion packing. A spillover object(s) from a portion may be classified into another group (e.g., second objects) or may be discarded in some approaches.

In some examples, the method 100 may include selecting a packing (e.g., first portion packing, second portion packing, and/or build volume packing) based on the chromosomes (e.g., chromosomes after a generation or generations). For example, the method 100 may include selecting a packing based on a fitness score (e.g., ranking, value(s), packing score, packing density, packing height, etc.). In some examples, the method 100 may include determining the fitness score based on a placement procedure. For example, the apparatus may use the placement procedure described above to evaluate a fitness score for each chromosome resulting from the genetic procedure. In some examples, selecting the packing is based on the genetic procedure with an objective. For instance, the apparatus may select a chromosome that represents a packing with a highest ranking, best value(s), best packing score, maximum quantity of packed objects, best fitness score, maximum packing density, and/or minimum height, etc. In some examples, the apparatus may select the packing based on an objective (e.g., packing density, quantity of packed objects, packing height, and/or fitness, etc.) or a combination of objectives. For instance, a packing with a best combination of objectives, such as quantity of packed objects, packing density, packing height, and/or fitness score, may be selected. In some examples, a group packing or packings may be selected to produce a build volume packing. For instance, packing 104 the first objects may include selecting a first portion packing (that best meets an objective or combination of objectives in some examples). In some examples, packing 106 the second objects may include selecting a second portion packing (that best meets an objective or combination of objectives in some examples). In some examples, the method 100 may include selecting a build volume packing (e.g., a packing for an entire build volume that best meets an objective or combination of objectives). For instance, the apparatus may select a build volume packing that includes a combination of a portion packing(s) and/or other packed object(s). For example, the apparatus may select a packing as a build volume packing that includes a first portion packing, a second portion packing, and other packed objects that best meets an objective(s).

In some examples, a packing(s) may be executed to manufacture the objects. For example, the objects may be manufactured by an apparatus (e.g., 3D printer) in accordance with the selected packing(s). For instance, an apparatus may send the packing(s) (e.g., portion packing(s) and/or build volume packing) to another device (e.g., 3D printer) or may execute the packing(s) to manufacture the objects in the packing(s). Some examples of the techniques described herein may be utilized in a variety of additive manufacturing. Some additive manufacturing techniques may be powder-based and driven by powder fusion. Some additive manufacturing techniques may include metal printing, such as metal jet fusion. Some examples of the approaches described herein may be utilized in powder bed fusion-based additive manufacturing, such as Selective Laser Melting (SLM), Selective Laser Sintering (SLS), MJF, etc.

In some examples, the method 100 may include presenting the selected packing(s). For instance, the apparatus may send an image(s) of the packing(s) to a display for presentation. In some examples, the method 100 may include sending the selected packing(s) to another device (e.g., computing device, server, etc.). For instance, the apparatus may transmit the selected packing(s) to another device via a network (e.g., a local area network, the Internet, etc.).

FIG. 2 is a block diagram of an example of an apparatus 202 that may be used in object packing. The apparatus 202 may be an electronic device, such as a personal computer, a server computer, a printer, a 3D printer, a smartphone, a tablet computer, etc. The apparatus 202 may include and/or may be coupled to a processor 204 and/or a memory 206. In some examples, the apparatus 202 may be in communication with (e.g., coupled to, have a communication link with) an additive manufacturing device (e.g., a 3D printing device). In some examples, the apparatus 202 may be an example of a 3D printing device. The apparatus 202 may include additional components (not shown) and/or some of the components described herein may be removed and/or modified without departing from the scope of the techniques described herein.

The processor 204 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 206. The processor 204 may fetch, decode, and/or execute instructions (e.g., object classification instructions 210 and/or genetic procedure instructions 214) stored in the memory 206. In some examples, the processor 204 may include an electronic circuit or circuits that include electronic components for performing a function or functions of the instructions (e.g., object classification instructions 210 and/or genetic procedure instructions 214). In some examples, the processor 204 may perform one, some, or all of the functions, operations, elements, methods, etc., described in relation to one, some, or all of FIGS. 1-4.

The memory 206 may be any electronic, magnetic, optical, or other physical storage device that contains or stores electronic information (e.g., executable instructions, executable code, and/or data). The memory 206 may be, for example, Random Access Memory (RAM), Electrically Erasable Programmable Read-Only Memory (EEPROM), a storage device, an optical disc, and the like. In some examples, the memory 206 may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 206 may be a non-transitory tangible machine-readable (e.g., computer-readable) storage medium, where the term “non-transitory” does not encompass transitory propagating signals. In some examples, the memory 206 may include multiple devices (e.g., a RAM card and a solid-state drive (SSD)).

In some examples, the apparatus 202 may include a communication interface (not shown in FIG. 2) through which the processor 204 may communicate with an external device or devices (not shown), for instance, to receive and store information (e.g., object data 208) pertaining to an object or objects to be manufactured (e.g., printed). The communication interface may include hardware and/or machine-readable instructions to enable the processor 204 to communicate with the external device or devices. The communication interface may enable a wired and/or wireless connection(s) to the external device or devices. The communication interface may further include a network interface card and/or may also include hardware and/or machine-readable instructions to enable the processor 204 to communicate with various input and/or output devices, such as a keyboard, a mouse, a display, another apparatus, electronic device, computing device, etc. In some examples, the apparatus 202 may receive instructions via an input device from a user.

In some examples, the memory 206 may store object data 208. The object data 208 may be obtained (e.g., received) from an external device and/or may be generated on the apparatus 202. For example, the processor 204 may execute instructions (not shown in FIG. 2) to receive the object data 208 from an external device.

The object data 208 may include data indicating objects and/or shapes (e.g., 3D models, dimensions, mesh models, voxels, etc.) of objects. For example, the object data 208 may indicate objects for packing and/or manufacture.

In some examples, the processor 204 may execute object classification instructions 210 to classify a set of objects based on a criterion to produce first objects and second objects. In some examples, classifying the first objects and the second objects may be performed as described in relation to FIG. 1. For instance, the processor 204 may classify objects as first objects in accordance with a criterion (e.g., whether an object is concave, whether the object has a top priority, and/or whether the object meets a geometrical complexity criterion, etc.).

In some examples, the processor 204 may determine a first portion based on the first objects. For instance, the processor 204 may determine the first portion as a proportion (e.g., 80%) of a volume of a sum of bounding box volumes of the first objects.

In some examples, the processor 204 may execute the genetic procedure instructions 214 to pack, using a genetic procedure, the first objects in a first portion of a build volume. In some examples, packing the first objects in the first portion may be performed as described in relation to FIG. 1. For instance, the processor 204 may iteratively perform mutation, evaluation, and/or selection on the first objects to pack the first objects within the first portion.

In some examples, the processor 204 may determine a spillover object from the first objects. In some examples, determining a spillover object may be performed as described in relation to FIG. 1. For instance, if a first object does not fit within the first portion boundaries for a first portion packing, the processor 204 may designate the first object as a spillover object. The processor 204 may classify the spillover object as a second object. For instance, the processor 204 may re-classify the spillover object from a first object to a second object.

In some examples, the processor 204 may execute the genetic procedure instructions 214 to pack, using the genetic procedure, the second objects in the build volume. In some examples, packing the second objects in the build volume may be performed as described in relation to FIG. 1. For instance, the processor 204 may iteratively perform mutation, evaluation, and/or selection on the second objects to pack the second objects within the build volume. The second objects may be packed within the first portion, partially in the first portion, and/or outside of the first portion. In some examples, the second objects may be packed in a second portion.

In some examples, the apparatus 202 may perform manufacturing based on the packings. For example, the apparatus 202 may 3D print the packings and/or send the packings to a 3D printer for manufacturing.

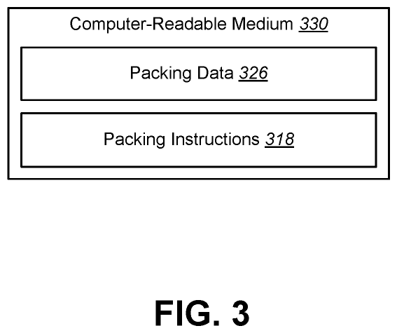

FIG. 3 is a block diagram illustrating an example of a computer-readable medium 330 for performing object packing. The computer-readable medium 330 is a non-transitory, tangible computer-readable medium 330. The computer-readable medium 330 may be, for example, RAM, EEPROM, a storage device, an optical disc, and the like. In some examples, the computer-readable medium 330 may be volatile and/or non-volatile memory, such as DRAM, EEPROM, MRAM, PCRAM, memristor, flash memory, and the like. In some examples, the memory 206 described in relation to FIG. 2 may be an example of the computer-readable medium 330 described in relation to FIG. 3.

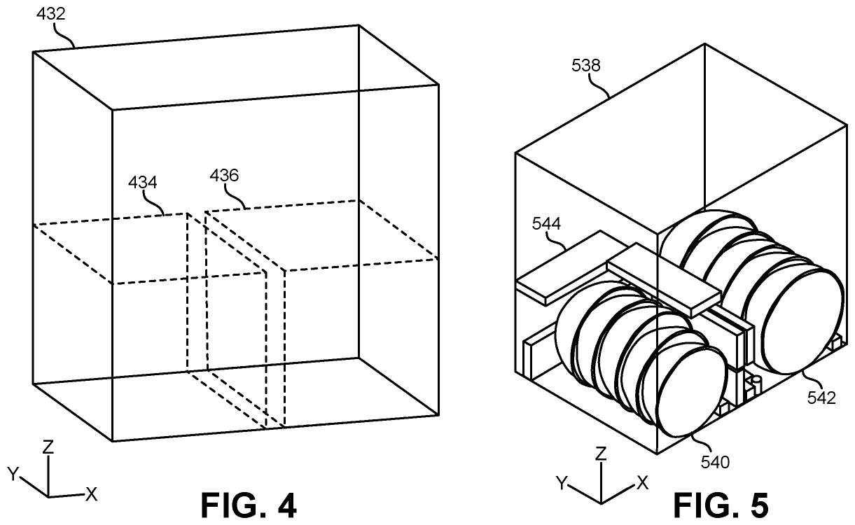

The computer-readable medium 330 may include data (e.g., information and/or instructions). For example, the computer-readable medium 330 may include packing data 326 and/or packing instructions 318. In some examples, the computer-readable medium 330 may include information and/or instructions to perform an operation or operations described in relation to FIG. 1, FIG. 2, FIG. 4, and/or FIG. 5.

The packing data 326 may include information indicating a plurality of packings. For example, the packing data 326 may indicate a set of packings, a population of packings, and/or generations of packings. For instance, operations may be performed as described herein to determine a plurality of chromosomes that represent packings. The chromosomes may be stored as packing data 326.

In some examples, the packing instructions 318 are instructions, when executed, cause a processor of an electronic device to pack, using a genetic procedure, a first portion of a build volume with first objects based on a first constraint. In some examples, packing a first portion of a build volume with first objects based on a first constraint may be performed as described in relation to FIG. 1 and/or FIG. 2. In some examples, the first constraint may be a first orientation. For instance, the first constraint may be an orientation constraint where a rotation on an axis is constrained to a roll angle (e.g., +22°) for the first objects. The genetic procedure may be allowed to change (e.g., mutate) a pitch angle, a yaw angle, and/or an order of the first objects and may be restricted from changing the roll angle. In some examples, a parameter or parameters (e.g., yaw, pitch, roll, order, voxel size, and/or spacing, etc.) may be constrained (e.g., set, restricted, etc.) based on a constraint. The genetic procedure may produce a packing (e.g., first portion packing) by performing evaluation, selection, crossover, and/or mutation subject to the constraint(s).

In some examples, the packing instructions 318 are instructions, when executed, cause a processor of an electronic device to pack, using the genetic procedure, a second portion of the build volume with second objects based on a second constraint. In some examples, packing a second portion of a build volume with second objects based on a second constraint may be performed as described in relation to FIG. 1 and/or FIG. 2. In some examples, the second constraint may be a second orientation. For instance, the second constraint may be an orientation constraint where a rotation on an axis is constrained to a roll angle (e.g., −22°) for the second objects.

In some examples, the first objects and the second objects may be copies of a prototype object. For instance, the packing instructions 318 may be executed to copy a prototype object to produce the first objects and second objects. The first objects may be packed in the first portion and second objects may be packed in the second portion with different constraints. For instance, the first constraint may be a first orientation and the second constraint may be a second orientation, where the first orientation is different from the second orientation.

To determine a packing in some examples, packing scores may be compared. A packing score is a score indicating a value or a combination of values (e.g., quantity of objects packed, fitness score, packing height, and/or packing density, etc.). An example of packing selection is given as follows. Assume two packings A and B with corresponding packing scores s_A and s_B. In some examples, a packing score s_X may include parameters (e.g., k parameters or values): s_X={p1_X, p2_X, . . . , pk_X}, where px_X is a parameter or value. A quantity (e.g., k) of threshold values may be utilized: α, β, . . . , φ. If the first k−1 parameters of each packing are relatively closer to each other (up to an adjustable threshold), a Boolean value of (p1_A>p1_B) may indicate whether s_A is greater than s_B. For instance, in a case that abs(p1_A−p1_B)<α and abs(p2_A−p2_B)<β and so on for the rest of the parameters, and (pk_A !=pk_B), then a Boolean value of (pk_A>pk_B) may indicate whether s_A is greater than s_B. Otherwise, a parameter number k−1 may be compared. For instance, in a case that abs(p1_A−p1_B)<α and abs(p2_A−p2_B)<β and so on for the rest of the parameters, and (pk−1_A !=pk−1_B), then a Boolean value of (pk−1_A>pk−1_B) may indicate whether s_A is greater than s_B. Otherwise, similar comparisons may be made for a parameter or parameters (e.g., pk−2_A !=pk−2_B and so on) until the final case, where (p1_A>p1_B) may indicate whether s_A is greater than s_B. The packing with the greatest score may be selected. In some examples, one parameter or multiple parameters (e.g., values) may be utilized in the comparison.

In some examples, the computer-readable medium 330 may include instructions, when executed, cause a processor to manufacture the packing(s). For example, the processor may execute instructions and/or send instructions to another device (e.g., 3D printer) to manufacture the packing(s).

FIG. 4 is a diagram illustrating a perspective view of an example of a build volume 432 including a first portion 434 and a second portion 436 in accordance with some examples of the techniques described herein. In this example, the build volume 432 may have dimensions of 380 mm×284 mm×380 mm and the first portion 434 and the second portion 436 are located within the build volume 432.

In this example, a set of 30 objects are to be packed, including ten concave objects of multiple sizes to be packed in the first portion 434 and the second portion 436. For instance, the first portion 434 and the second portion 436 may have concave object constraints. The 20 remaining objects with multiple geometries are to be packed in the remaining free space inside the build volume 432, which may include free space next to or inside concave objects in the first portion 434 and the second portion 436.

In this example, the dimensions of the first portion 434 and the second portion 436 may be determined based on bounding box dimensions of the concave objects for packing. For instance, the X and Z dimensions of the first portion 434 and the second portion 436 may be determined as the largest X dimension of the concave objects and the largest Z dimension of the concave objects.

In some examples, the first portion 434 and the second portion 436 may be indicated by opposite points of a cuboid. For instance, the first portion 434 may be indicated as ranging from (0, 0, 0) to (180, 284, 180) in mm, and the second portion 436 may be indicated as ranging from (200, 0, 0) to (380, 284, 180) in mm.

FIG. 5 is a diagram illustrating a perspective view of an example of a packed build volume 538 in accordance with some examples of the techniques described herein. The packed build volume 538 is an example of the build volume 432 described in relation to FIG. 4 after packing in accordance with some examples of the techniques described herein.

In this example, a first genetic procedure instance may be executed to pack as many of the ten concave objects as possible in the first portion 434. The first genetic procedure instance is executed to pack five concave objects in the first portion 434. FIG. 5 illustrates a first row 540 of the first objects (five concave objects). Spillover objects remaining after the first genetic procedure instance (remaining five concave objects) are classified as second objects corresponding to the second portion 436. A second genetic procedure instance is executed to pack the remaining five concave objects in the second portion 436. FIG. 5 illustrates a second row 542 of the second objects (remaining five concave objects). A third genetic procedure instance is executed to pack the 20 other objects in the free space. An example of an object 544 of the third objects (20 other objects) is illustrated in FIG. 5. As illustrated in FIG. 5, some of the third objects are next to, between, and above the concave objects. The example of FIG. 5 illustrates how some of the techniques described herein may reduce a search space for packing (e.g., increasing concave object nesting) relative to dealing with large combinatorial possibilities of a full object pool and/or entire build volume.

Some examples of the techniques described herein may allow performance of multiple packing strategies and/or heuristics applicable to a geometric variety of objects. In some examples, each strategy may target a different objective.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be implemented within the scope of the disclosure. For example, aspects or elements of the examples described herein may be omitted or combined.

1. A method, comprising:
determining a first portion within a build volume;
packing, using a genetic procedure, first objects in the first portion; and
packing, using the genetic procedure, second objects in the build volume.

2. The method of claim 1, further comprising classifying a set of objects to determine the first objects and the second objects.

3. The method of claim 2, wherein classifying the set of objects is based on a criterion.

4. The method of claim 1, wherein packing the first objects in the first portion is based on a constraint associated with the first portion.

5. The method of claim 4, wherein the constraint associated with the first portion comprises voxel size, spacing, or orientation.

6. The method of claim 1, wherein the second objects are packed in a second portion within the build volume.

7. The method of claim 6, wherein packing the second objects in the second portion is based on a second constraint that is different from a first constraint associated with the first portion.

8. The method of claim 6, wherein the second portion overlaps with the first portion.

9. The method of claim 8, further comprising performing collision detection in an overlapping region between the first portion and the second portion.

10. An apparatus, comprising:
a memory;
a processor coupled to the memory, wherein the processor is to:
classify a set of objects based on a criterion to produce first objects and second objects;
pack, using a genetic procedure, the first objects in a first portion of a build volume; and
pack, using the genetic procedure, the second objects in the build volume.

11. The apparatus of claim 10, wherein the processor is to determine the first portion based on the first objects.

12. The apparatus of claim 10, wherein the processor is to:
determine a spillover object from the first objects; and
classify the spillover object as a second object.

13. A non-transitory tangible computer-readable medium comprising instructions when executed cause a processor of an electronic device to:
pack, using a genetic procedure, a first portion of a build volume with first objects based on a first constraint; and
pack, using the genetic procedure, a second portion of the build volume with second objects based on a second constraint.

14. The non-transitory tangible computer-readable medium of claim 13, wherein the first objects and the second objects are copies of a prototype object.

15. The non-transitory tangible computer-readable medium of claim 13, wherein the first constraint is a first orientation, and the second constraint is a second orientation.
